(19) United States
(12) Patent Application Publication
(10) Pub. No.: US 2008/0039056 A1
(43) Pub. Date: Feb. 14, 2008

(54) SYSTEM AND METHOD FOR INTERACTION OF A MOBILE STATION WITH AN INTERACTIVE VOICE RESPONSE SYSTEM

(75) Inventors: Ajit Mathews, Plantation, FL (US); Bert Van Der Zaag, Coconut Creek, FL (US)

Correspondence Address: MOTOROLA, INC., 1303 EAST ALGONQUIN ROAD, IL01/3RD, SCHAUMBURG, IL, 60196, US

(73) Assignee: Motorola, Inc., Schaumburg, IL (US)

(21) Appl. No.: 11/427,026

(22) Filed: Jun. 28, 2006

(51) Int. Cl. H04Q 7/38; H04Q 7/22; H04M 3/42

(52) U.S. Cl. 455/414.1

(57) ABSTRACT

A communication session is established between a mobile station (102) and an interactive voice response (IVR) system (106). One or more menu options in a speech form are received at the mobile station (102). The mobile station (102) converts these menu options from the speech form to a displayable form. A stored menu at the mobile station (102) is updated with the displayable form. The updated menu may then be presented to the user. The menu options reflected in the displayable form may be stored in at the mobile station (102) and/or at external devices that may or may not be associated with the IVR system (106).

### FIELD OF THE INVENTION

The field of the invention relates to mobile stations and, more specifically, to the interaction of mobile stations with other devices and systems.

### BACKGROUND OF THE INVENTION

Various types of mobile stations are utilized in today's communication networks. For example, users frequently use two-way radios (including but not limited to cellular phones, push-to-talk platforms and the like), pagers, personal digital assistants, and computers to communicate with each other.

Interactive Voice Response (IVR) systems are also in widespread use. For example, a user may communicate with an IVR system at a bank and, using voice commands, navigate through the IVR system to obtain account, balance, and other types of information. In many IVR systems, the user navigates through various nodes in the system. At each node, options may be presented to the user, and information may be obtained from the user (e.g., via a keyboard or voice commands). In one specific example, at a node in a banking IVR system, voice commands may be obtained from the user that describe the type of account (e.g., checking or savings account) for which the user desires information.

IVR systems can typically be accessed by mobile stations. For instance, a user on their cellular phone can call the IVR system at their bank and determine their account balance and the latest transactions that were accredited to their account.

Unfortunately, previous mobile stations only provide for audio interactions with IVR systems and several problems may occur as a result of this voice-only interaction. For instance, a user may be in the middle of a session with the IVR system, forget where they are located within the IVR system, and become confused. In other situations, the user may be at a node within the IVR system where a list of options for proceeding are read to them. However, by the time the options are fully read to the user, the user may forget some or all of the options, thereby confusing and frustrating the user. As a result of these problems, IVR systems become less convenient to use as the user is forced to replay commands. The efficiency of the user in utilizing the system also becomes significantly reduced.

### BRIEF DESCRIPTION OF THE DRAWINGS

The above needs are at least partially met through provision of a system and method for interaction of a mobile station with an interactive voice response system described in the following description, particularly when studied in conjunction with the drawings, wherein:

FIG. 1 is a block diagram of a system for providing a menu of an Interactive Voice Response (IVR) system at a mobile station according to various embodiments of the present invention;

FIG. 2 is a block diagram of a transmitter that interacts with an IVR system according to various embodiments of the present invention;

FIG. 3 is a flowchart of an approach for allowing a mobile station to interact with an IVR system according to various embodiments of the present invention;

FIG. 4 is a flowchart of an approach for providing interactions between a mobile station and an IVR system according to various embodiments of the present invention; and

FIG. 5 is a diagram showing the display of a mobile station showing a menu according to various embodiments of the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method provide for a menu from an Interactive Voice Recognition (IVR) system to be visually presented to a user at a mobile station. As is known, an IVR system presents certain options from a menu comprising a set of options, using processor generated speech to present the options. The certain options presented depend upon interactions between a user and a telephone that may be made by speech or keypad entries. The menu that is visually presented, according to embodiments of the invention further described herein, also comprises at least some of the set of options, and in some embodiments, may comprise the entire set of options, and in some embodiments may consist of the same set of options. Since the user can see the menu, the user can conveniently navigate through the IVR system without becoming lost or confused. The display of the menu at the mobile station also enhances the productivity and efficiency of the user since the user can more quickly navigate through the IVR system.

Additionally, in the embodiments described herein, no changes or modifications are required to IVR systems. A menu can be developed at the mobile station from user inputs (e.g., speech) and stored (along with the interactions) at the mobile station or an external device (e.g., a server). Consequently, if a service disruption occurs between the mobile station and the IVR system, the user can still utilize the updated menu and not be forced to recall their previous interactions with the menu.

In many of these embodiments, a communication session is established between a mobile station and an interactive voice response (IVR) system. One or more menu options in a speech form are received at the mobile station. The mobile station converts these menu options from the speech form to a displayable form. A stored menu at the mobile station is updated with the displayable form. The updated menu may then be presented to the user. The menu options reflected in the displayable form may be stored in at the mobile station and/or at external devices (e.g., servers) that may or may not be associated with the IVR system.

The interactions of the user with the menu may also be communicated to the IVR system. For example, the user may enter account information when the IVR system is a banking system. The IVR system then receives and processes the information and may form response information. For example, the IVR system may determine an account balance when the IVR system is a banking system. The IVR system sends this response information to the mobile station and the mobile station may then receive and display the response information. The IVR system may present audible interactions when interacting with the user.

In many of these embodiments, users may frequently move within a network thereby losing contact with a network, and then be required to re-establish the connection. In addition, the user may deactivate and then re-activate their mobile station. Consequently, in either situation, communication with the IVR system may become severed and subsequently restored. Since the menu is stored in memory at the mobile station, the menu can be recalled and displayed to the user quickly and automatically. Conveniently, the retrieved menu can reflect the previous interactions of the user from the point in time when the disruption occurred.

Various types of interactions of the user with the menu may be accepted at the mobile station. For example, voice commands and keyboard user input may be accepted. Other types or combinations of interactions are possible.

In addition, the menu and interactions with the menu may be stored in various formats at a memory at the mobile station. For instance, the menu and the interactions may be stored as a data structure comprising nodes and identifying the node where the user is located. In another example, the menu may be stored in a data structure comprising node and textual pairs. Other types of data structures or representations may also be used to store the menu and user interactions.

Thus, the approaches described herein provide for a visual display of a menu to a user at a mobile station. Since the user can see the menu, they can conveniently navigate through an IVR system without becoming lost or confused. Additionally, no changes or modifications are required to the IVR system and the menu and user interactions with the menu can be stored for future use. Consequently, convenient and quick navigation is possible through the menu even if communications with the IVR system become disrupted. User productivity and efficiency are also enhanced.

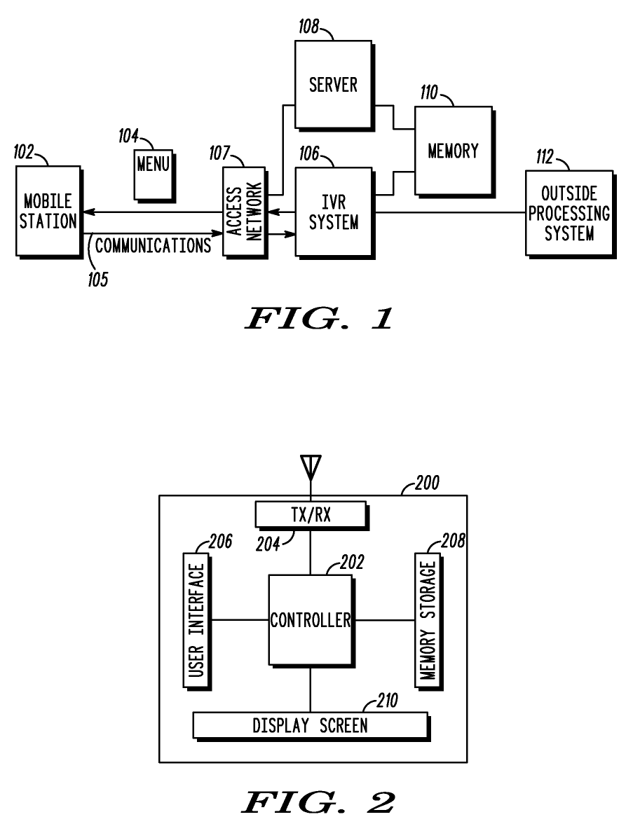

Referring now to FIG. 1, one example of a system for interacting with an Interactive Voice Recognition (IVR) system is described. A mobile station 102 sends communications 105 to an IVR system 106 via an access network 107. The mobile station 102 may be any type of mobile communication device such as a cellular phone, pager, personal computer, or personal digital assistant. In addition, the communications 105 may be any type of wireless communication. For instance, the communications 105 can be messages that establish communications with the IVR system 106. The mobile station 102 may include a microphone and speaker (not shown) to allow for speech interactions with the IVR system 106.

The access network 107 includes functionality to receive signals from the mobile station 102 and convert these signals into a suitable form for presentation to the IVR system 106. In this regard, the access network 107 may include base stations, servers, and other devices that allow communications to be exchanged between the mobile station 102 and the access network 107.

The server 108 may also communicate with the mobile station 102 via the access network 107 and may be separate from or part of the IVR system 106. In addition, additional servers may be used.

The memory 110 stores information used by the server 108 and the IVR system 106. The memory 110 may be any type of memory device or any combination of memory storage devices such as Read Only Memory (ROM) or Random Access Memory (RAM) devices.

An outside processing system 112 may be coupled to the IVR system 106. The outside processing system 112 may offer additional processing functionality in support of the IVR system 106. In one example, the outside processing system 112 may be an external credit card processing system that interacts with the IVR system and/or the server 108. Other examples of outside processing systems are possible.

In one example of the operation of the system of FIG. 1, the mobile station 102 sends a communication to the IVR system 106. The communication, for example, may be in the form of a telephone call. The IVR system 106 receives the communication. If a menu is not already stored at the mobile station 102, the mobile station 102 may acquire a menu from the server 108, or in some embodiments from the IVR system to be displayed at the mobile station 102. (Those skilled in the art will understand that this can comprise transmitting the complete menu prior to effecting such a display or can, if desired, comprise sending (at least initially) an abridged version of the display and displaying that abridged version prior to the complete menu becoming locally available at the mobile station 102).

The mobile station 102 then receives and displays the menu. The menu visually presents at least one option for interacting with the IVR system 106. Interactions of a user with the menu are also accepted at a user interface on the mobile station 102. The menu and the interactions of the user with the menu are stored in a memory at the mobile station 102. Textual information entered by the user at any node of the menu may also be stored in the memory at the mobile station 102. The IVR system 106 may present options by speech when interacting with the user. The mobile station 102 may convert the interactions (i.e., the menu options selected by the user) to a displayable form and apply these to the menu. This updated menu may then be presented to the user at the mobile station.

In some embodiments, no changes are required to the IVR system 106. Consequently, a menu can be developed at the mobile station 102 from options (e.g., the initially downloaded menu) received from the IVR system 106. As mentioned, the interactions (e.g., speech menu options) of the user are used to update or modify the menu. These interactions of the user can also be stored so that after the mobile station becomes reconnected to the IVR system 106 after a disconnection, the user can quickly be presented with their previous menu position and/or navigate through the menu to find this position. In this regard, the interactions stored in a displayable format may be applied to the stored menu so that an updated menu can be presented to the user even after disconnection with the IVR system 106 occurs.

The interactions of the user may also be communicated to the IVR system 106. For example, the user may enter account information when the IVR system 106 is a banking system. The IVR system 106 then receives and processes the information and may form response information. For example, the IVR system 106 may determine an account balance when the IVR system 106 is a banking system. The IVR system 106 sends this response information to the mobile station 102 and the mobile station 102 may display the response information. The IVR system 106 may interact with the outside processing system 112. In the present example, the outside processing system 112 may be a credit card processing system that interacts with the banking system.

Users may frequently move within a network or may deactivate and activate the mobile station 102. Consequently, communications with the IVR system 106 may become severed and subsequently restored (with such restoration occurring quickly following such severance, or, in some cases, considerably later). Since the menu is stored in the memory at the mobile station 102, the menu can be recalled and displayed to the user quickly and conveniently. The menu stored at the mobile station 102 stores information about where in the menu the user was located when the disconnect occurred, the phone number of the IVR system, or any other information needed to reconnect with the IVR system 106. In other words, the stored menu reflects the previous interactions of the user. Additionally, the menu can be stored at either the IVR system or some other external device.

In addition, the menu and interactions with the menu may be stored in various formats at a memory at the mobile station 102. For instance, the menu and the interactions may be stored as a data structure that identifies nodes and as well as where the user is located relative to the nodes. In another example, the menu may be stored in a data structure comprising node and textual pairs. In this case, each node includes associated text (if any) entered by the user at the node. Other data structures may also be used to store and represent the menu and user interactions.

Additionally, the menu may originate from various places within the system. For example, at least portions of the interactive menu may be received at the mobile station 102 from the server 108 or from other servers (not shown).

In another example, a version of a locally stored menu at the mobile station 102 may be compared with a present currently-used menu as is being used by the IVR system 106. Upon determining that the mobile station 102 has an outdated menu, the mobile station 102 can update that version by receiving only information regarding deletions and/or additions by which to modify the presently locally stored outdated menu. This, in turn, will permit the mobile station 102 to have an updated menu without necessarily requiring the entire new version of the menu to be transmitted, thereby potentially saving both time and bandwidth.

Referring now to FIG. 2, one example of a mobile station 200 that interacts with an IVR system is described. The mobile station 200 includes a controller 202. The controller 202 is coupled to a transmit/receive circuit 204, user interface 206, memory storage 208, and a display screen 210. The mobile station 200 may also include a speaker/microphone to provide speech interactions with an IVR system.

The transmit/receive circuit 204 is any type of circuit using any combination of hardware and/or software components that is adapted to transmit and receive information from the IVR system. The user interface 206 may be any type of interface that allows the user to enter information. In this regard, the user interface 206 may be a microphone or keypad. Other examples of user interfaces are possible.

The memory storage 208 is any type of memory storage device. The memory storage 208 stores the menu and the interactions of the user with the menu (e.g., position of the user and data entered). The display screen 210 displays the menu and may be part of the user interface 206. The display screen 210 may be a touch screen to allow the user to enter commands.

The controller 202 is programmed to initially receive the menu from the IVR system at the receiver. Alternatively, if the menu already exists in the memory storage device 208, the menu may be retrieved from memory storage device 208 by the controller 202. The controller 202 displays the menu on the display screen and stores the menu (and the interactions of the user with the menu) in the memory storage device 208.

The menu can be developed at the mobile station 200 from options (e.g., the initially downloaded menu) received from the IVR system. The user may enter speech options into the user interface 206. The controller 202 then converts the menu options from the speech form to a displayable form. The menu stored in the memory storage 208 is updated with the displayable form. The updated menu may then be presented to the user on the display screen 210. The menu options in the displayable form (i.e., reflecting the interactions of the user) may also be stored in the memory storage 208 for future use.

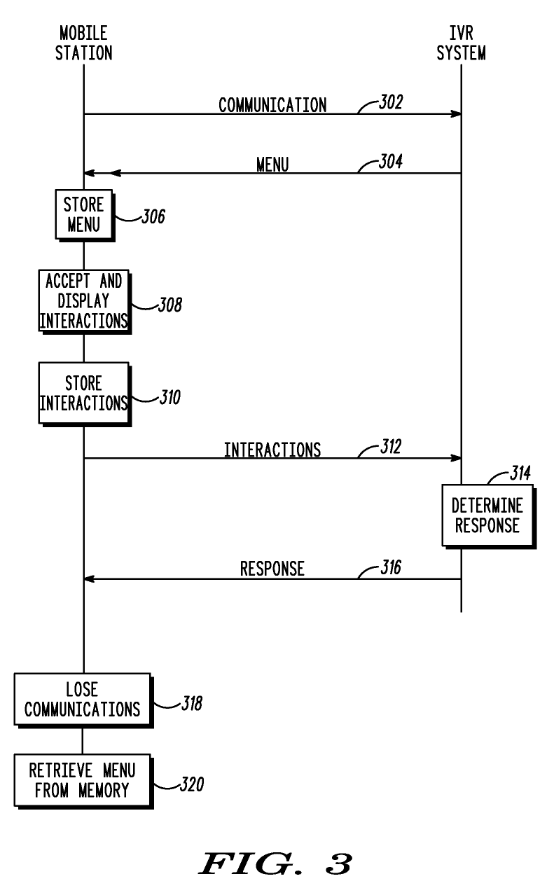

Referring now to FIG. 3, one example of an approach for allowing a mobile station to interact with an IVR system is described. At step 302, a communication is sent from the mobile station to the IVR system. The communication may establish an initial link with the IVR system where no previous link existed.

At step 304, a menu is returned from the IVR system to the mobile station. The menu may be in any suitable data format or structure. At step 306, the menu is stored in a memory storage device at the mobile station.

At step 308, the mobile station accepts and displays interactions from the user with the menu. In this regard, the user may enter speech input in a microphone and the mobile station may update the menu to reflect these inputs. For example, the current node where the user is located in the system may be highlighted.

At step 310, the interactions of the user are stored in the memory at the mobile station. The interactions may indicate where the user is located and the data entered by the user at particular nodes.

At step 312, the interactions are communicated to the IVR system. For example, if the user enters account information, the account information may be communicated to the IVR system.

At step 314, the IVR system determines a response. For example, the system may locate account balances or other types of information when needed. At step 316, the response is communicated from the IVR system to the mobile station.

At step 318, a communication break occurs between the mobile station and the IVR system. For example, the user may deactivate the mobile station or move from a coverage area and that allows the mobile station become unconnected to the network.

At step 320, the mobile station re-establishes communications and retrieves the menu from the memory at the mobile station. The menu is updated to include the interactions provided by the user. Specifically, the menu stored at the mobile station stores information about where in the menu the user was located when the disconnect occurred, the phone number of the IVR system, or any other information needed to reconnect with the IVR system. Consequently, since the menu (and interactions with the menu) are already stored at the mobile station, time and communication bandwidth are conserved since the state of the menu reflects the interactions of the user. The user has the opportunity to conveniently continue with their prior session with the IVR system (if the IVR system has maintained the position in the menu where the user was disconnected), or allows the user to quickly maneuver back to the position in the menu where the user was disconnected (if the IVER system has reset).

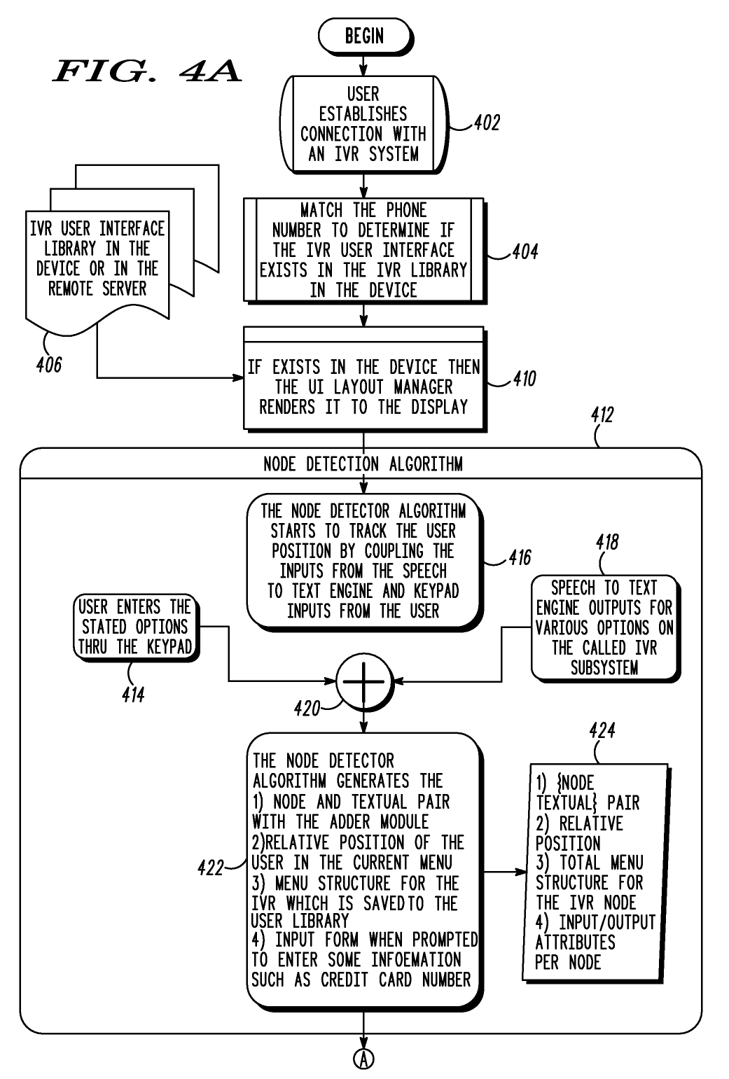

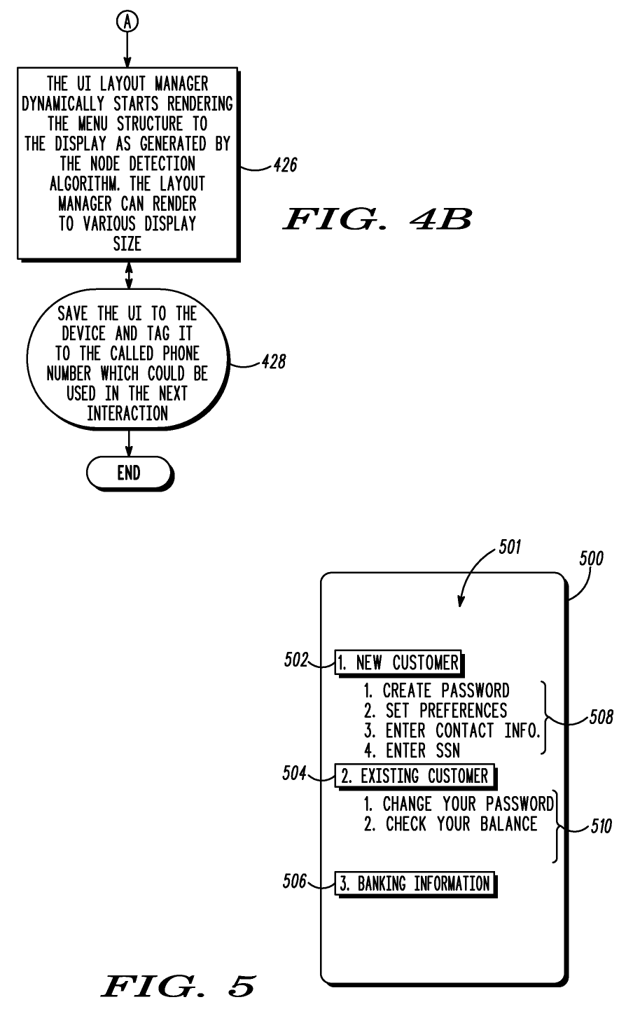

Referring now to FIG. 4, another example of an approach for providing interactions between a mobile station and an IVR system is described. At step 402, the user establishes a connection with the Interactive Voice Recognition (IVR) system using the IVR phone number.

At step 404, the mobile station matches the IVR phone number to menus stored in the IVR library at the mobile station to determine if the menu exists in the IVR library at the mobile station or whether a download from the IVR system is required.

At step 406, the menu is retrieved from the IVR user interface library at the mobile station (if the menu exists at the mobile station) or from a remote server 406 (if the menu does not already exist at the mobile station and the mobile station). At step 410, the menu is received and rendered on the display of the mobile station.

A node detection algorithm 412 is then entered. At step 416, the node detection algorithm starts to track the user position within the menu. For instance, the node detection algorithm couples the inputs from a speech-to-text engine (which receives voice commands from the user at step 418) and keypad inputs from the user entered on a keypad of the mobile station (received at step 414).

At 420, the IVR system, using an adder module, assembles the inputs together to produce results 422. Specifically, the adder module produces node-text pairs that identify a node and relate this node to any information (e.g., voice information received from the voice-to-text engine or keypad information) entered at that node by the user. The results 422 also include the relative position of the user in the menu. This position may be represented by any convenient approach such as marking a node in the node-text pair or by storing the name of the node where the user is currently located. Additionally, the results 422 include the menu structure for the current IVR system. For instance, the menu structure may be a linked list describing the menu. Finally, the results include input received from the user, such as credit card information, and the node where the information was entered.

At step 426, a layout manager dynamically renders the menu structure to a display (e.g., screen) at the mobile station. Advantageously, the layout manager is programmed to render various sized displays depending upon the requirements of the user and/or the requirements of the mobile station. At step 428, the menu structure is saved to the mobile station and tagged with the called telephone number so that the menu can be easily recalled and used for the next interaction of the user with the IVR system.

Referring now to FIG. 5, a diagram showing the display of a mobile station with a menu is described. A user interface 500 includes a menu 501 including various groups of commands. This particular example illustrates a menu 501 that can be displayed for a banking system. Other menus types of menus for this and other types of IVR systems also may be used in the present approaches.

The menu is displayed on a screen of the mobile station. Main menu commands 502 (“New customer”), 504 (“Existing customer”), and 506 (“Banking Information”) are initially entered by the user. The user may speak these commands or type them in with a keypad.

A command group 508 relates commands for new customers and a command group 510 relates to commands for existing customers. For example, if the user wishes to enter the new customer menu, they may say “1” or type in “1” from their keypad when prompted to do so by the IVR system. The user may provide a voice command or enter the information by using the keypad. For example, if the user (who has initially entered the new customer menu 502) wishes to enter their social security number, the user may type “4” on the keypad or say “4.”

Thus, these approaches provide a menu to a user at a mobile station as well as permit developing a local history of the user's interactions with the menu. Since the user can see the menu, they can conveniently navigate through an IVR system without becoming lost or confused. In addition, no changes are required to IVR systems using the present approaches. A displayable menu can be developed at the mobile station from inputs (e.g., speech) received from the users and stored at the mobile station. Consequently, a user can quickly find their place in the menu even if communications with the IVR system are lost. The productivity and efficiency of the user is also enhanced.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method of interfacing with an interactive voice response (IVR) system comprising:
at a mobile station:
establishing a communication session with an interactive voice response (IVR) system;
receiving one or more menu options in a speech form from a user;
converting the one or more menu options from the speech form to a displayable form; and
updating a stored menu with the displayable form.

2. The method of claim 1 further comprising storing the displayable form in a memory storage device.

3. The method of claim 1 further comprising storing the menu at a system server not associated with the IVR system.

4. The method of claim 1 further comprising storing the menu at a system server that is associated with the IVR system.

5. The method of claim 1 further comprising applying the displayable form to the stored menu during a subsequent communication session.

6. The method of claim 1 wherein receiving menu options further comprises accepting keyboard user input.

7. The method of claim 1 wherein the stored menu comprises at least one node identifying a user location in the menu.

8. The method of claim 1 wherein the stored menu comprises at least one node and textual pair in the memory storage device.

9. A method of interfacing with an interactive voice response (IVR) system comprising:
at a mobile station:
establishing an initial communication session with an interactive voice response (IVR) system;
downloading an initial menu from a system server;
receiving one or more menu options in a speech form from a user;
converting the one or more menu options from the speech form to a displayable form; and
updating the initial menu with the displayable form to form an updated menu;
becoming disconnected from the initial communication session and establishing a subsequent communication session; and
providing the updated menu to the user after establishing the subsequent communication session.

10. The method of claim 9 further comprising storing the displayable form in a memory storage device.

11. The method of claim 9 further wherein the system server is not associated with the IVR system.

12. A mobile station comprising:
a display screen;
an interface for receiving one or more menu options in a speech form;
a memory storage device for storing a menu; and
a controller communicatively coupled to the interface, the memory storage device, and the display screen, the controller responsively converting the one or more menu options from the speech form to a displayable form and updating the menu with the displayable form to form an updated menu, the controller further programmed to present the updated menu to the user on the display screen.

13. The mobile station of claim 12 wherein the interface comprises a microphone.

14. The mobile station of claim 12 wherein the interface further comprises a keypad and the interfaces accepts textual inputs.

15. The mobile station of claim 12 wherein the controller is further programmed to communicate the menu options to an interactive voice response (IVR) system and responsively receive response information from the IVR system.

16. The mobile station of claim 15 wherein the controller is further programmed to display the response information to the user on the display screen.

17. The mobile station of claim 12 wherein the controller is further programmed to store the updated menu in the memory storage device and retrieve and display the updated menu stored in the memory storage device after communications with the IVR system have been severed and subsequently restored.
